(19) United States
(12) Patent Application Publication
(10) Pub. No.: US 2017/0265600 A1
(43) Pub. Date: Sep. 21, 2017

(54) DEVICES AND METHODS FOR SEPARATING CONTACTING SURFACES

(71) Applicant: David Winsen, Burbank, CA (US)

(72) Inventor: David Winsen, Burbank, CA (US)

(21) Appl. No.: 15/071,808

(22) Filed: Mar. 16, 2016

(51) Int. Cl. A44B 15/00; B25B 33/00

(52) U.S. Cl. CPC A44B 15/007; B25B 33/00

(57) ABSTRACT

The present technology is directed to tools and methods for separating contacting surfaces, as in the case of a keychain, for ease of adding and removing a small personal item such as a key, from between the contacting surfaces.

### TECHNICAL FIELD

The present technology relates generally to novel apparatuses and methods for separating contacting surfaces, particularly two contacting rings or surfaces of a tool such as a keychain, to permit easier addition or removal of a key or other item through a space between the two rings or surfaces.

### BACKGROUND

Keychains and other devices that include separate contacting rings or surfaces are useful for carrying small personal items such as keys. However, to serve their purpose of providing a firm hold on the small personal items, it is often necessary for such devices to include different parts that are held together firmly or tightly, with little room for maneuvering between the two surfaces, or of moving the two surfaces relative to each other. This firm or tight fit is generally desirable to prevent the loss of the personal items; but on the other hand, can make it more difficult to add and remove such items that are held between the two contacting surfaces. Thus, it can be difficult to separate the contacting surfaces to insert a key or small personal item into a keychain, and conversely to remove it from the keychain.

Users often report that attempting to insert a key or personal item into a keychain, or to remove it from the keychain, often leads to at least, annoyance and inconvenience, and at worst, injury to the hands or fingernails or loss of the key or personal item. However, keychains that are designed to permit separation of the two surfaces (and thus easier addition or removal of keys and other personal items) have the disadvantage of being easily compromised and opened, thus leading to lost keys and personal items.

Thus, a need exists for apparatuses and methods that can lead to easy separation of the surfaces, but that also ensures a tight closure when the surfaces are not separated, and reliable securement of small personal items.

### SUMMARY

In certain embodiments, the present technology is directed to a tool configured to separate two contacting surfaces from each other, the tool comprising a tapered prong having a broad portion tapering to a pointed portion, the pointed portion configured to be inserted between the two contacting surfaces, causing the two contacting surfaces to be separated from each other by a distance that increases as the tapered prong is advanced between the two contacting surfaces.

In certain embodiments, the present technology is directed to a method of separating two contacting surfaces from each other, the method comprising inserting a tool discussed herein between the two contacting surfaces, separating them.

In certain embodiments, the present technology is directed to a method of inserting a small personal item onto a keychain comprising two surfaces in contact with each other, the method comprising the step of inserting the tool of claim 1 between the two surfaces to separate the surfaces and form a space between the two surfaces; and advancing the small personal item through the space.

In certain embodiments, the present technology is directed to a method of removing the a small personal item from a keychain comprising two surfaces in contact with each other, the method comprising the step of inserting the tool of Claim 1 between the two surfaces to separate the surfaces and form a space between the two surfaces; and advancing the small personal item through the space.

### DESCRIPTION OF THE DRAWINGS

FIG. 1 shows an embodiment of the present technology as it relates to two contacting surfaces.

FIG. 2 shows a view of another embodiment of the disclosed technology as the tool is being inserted between the contacting surfaces.

FIG. 3 shows a view of another embodiment of the disclosed technology as the tool is being inserted between the contacting surfaces and a small personal item is being advanced through the space between the two contacting surfaces.

FIG. 4 shows a view of another embodiment of the disclosed technology as the tool is being removed from between the contacting surfaces and a small personal item is being advanced through the space between the two contacting surfaces.

FIG. 5 shows a view of another embodiment of the disclosed technology as the small personal item is being advanced through the space between the two contacting surfaces.

FIG. 6 shows a view of another embodiment of the disclosed technology as the small personal item has been securely inserted between the two contacting surfaces.

### DETAILED DESCRIPTION

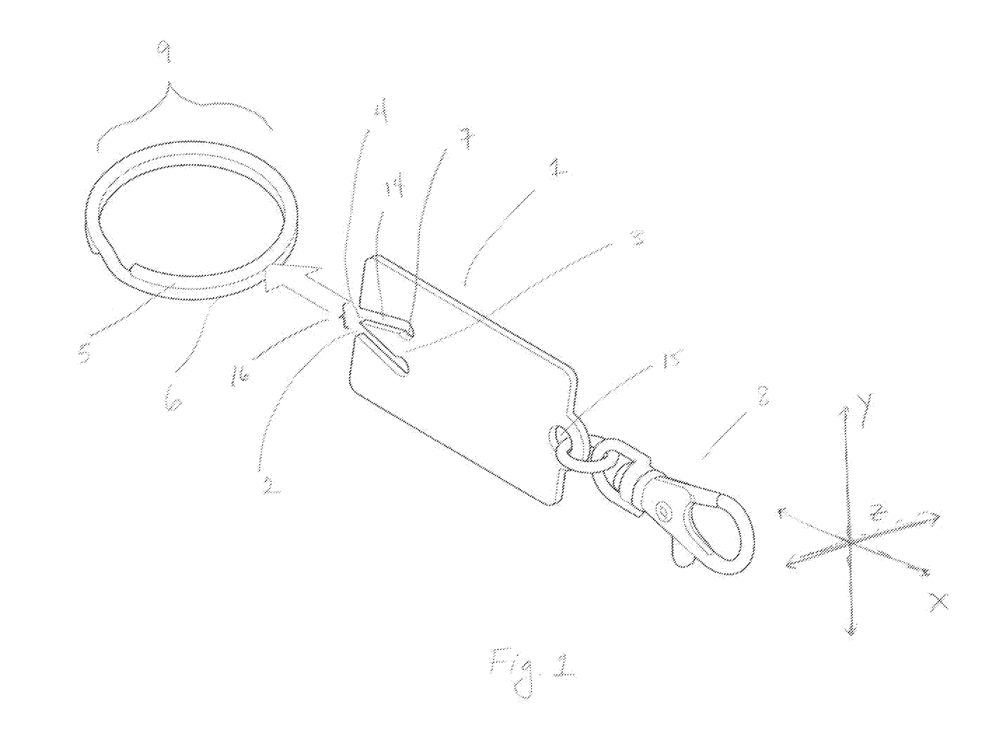

In certain embodiments, the tools herein can be used in connection with any device that includes two contacting surfaces that are held together partly or entirely through the mechanical shape of the two contacting surfaces, and not with any external mechanism such as adhesives, magnets or any other added force—and that a user decides to separate. For example, in the case of a keychain, the two contacting surfaces are typically contacted purely mechanically, e.g., as a collapsed helical coil or spiral that exerts forces keeping two contacting portions of the same piece of metal touching each other based solely on its shape, as can be seen, for example in FIG. 1. In other embodiments, the two contacting surfaces can be additionally held together through mechanisms such as an adhesive, magnetic force, a device holding them together (such as clamp, rope, a mechanical fastener or the like). So long as it is possible for a user to insert the apparatuses discussed herein between the two contacting surfaces and exert some force to separate them, the apparatuses herein can be used with any two contacting surfaces contemplated.

In certain embodiments, the two contacting surfaces discussed used herein are configured to carry a small personal item. For example, in the case of a keychain, the small personal item can be hooked to the device formed at least in part by the two contacting surfaces. As used herein, “contacting surfaces” refers to multiple surfaces of either the same piece of material (for example, an elongated piece of metal or other material coiled around itself so that different parts of it contact each other, each part constituting a “contacting surface” for the purposes of the present disclosure); or separate pieces of material (for example, two separate pieces of metal or other material configured to contact each other either mechanically or through some other means such as adhesive or the like).

As used herein, “carrying mechanism” means any mechanism that comprises two or more surfaces contacting each other in a resting or default position, where it is desirable to separate them temporarily to slip any item between them, and whereby the two contacting surfaces are then allowed to return to the resting or default position wherein they contact each other again. As used herein, carrying mechanisms include, but are not limited to, keychains, clasps and fastenings for jewelry and clothing, hardware, tools, toys and novelty items for recreational, scientific or medical purposes or anything useful for carrying items from one point to another.

As used herein, “small personal item” or “personal item” are interchangeable terms and mean anything that can be transported by attaching it to a keychain or other carrying mechanism comprising contacting surfaces; and can include any of the following: a key, flashlight, carabiner, bottle opener, nail clipper, safety item (e.g., a whistle, container of pepper spray, nightstick), container (e.g., for carrying food or drink or emergency medication whether topical, oral, inhalable, injectable or otherwise) knife, scissors, nail file, writing instrument, multifunction tool, razor, electronic item, tag, fob (e.g., remote keyless entry fob or security fob), jewelry, cellular phone, computer, game console, compass, or toy or trinket (e.g., charm).

In certain embodiments, a tool herein comprises a tapered prong that can be inserted between the contacting surfaces, and used to separate the contacting surfaces (for example, the contacting rings of a keychain). A keychain or other carrying mechanism can be of the type that includes one or more rings or portions of rings, for example as seen in FIGS. 1-6. The rings can be of any shape, including but not limited to circular, oblong, regular or irregular or having any shape with three or more sides (for example, a square, rectangle or the like). Moreover, the present technology contemplates tools for separating two or more or any number of contacting surfaces; for example, in various embodiments a tool in accordance with the technology herein can comprise two or more tapered prongs.

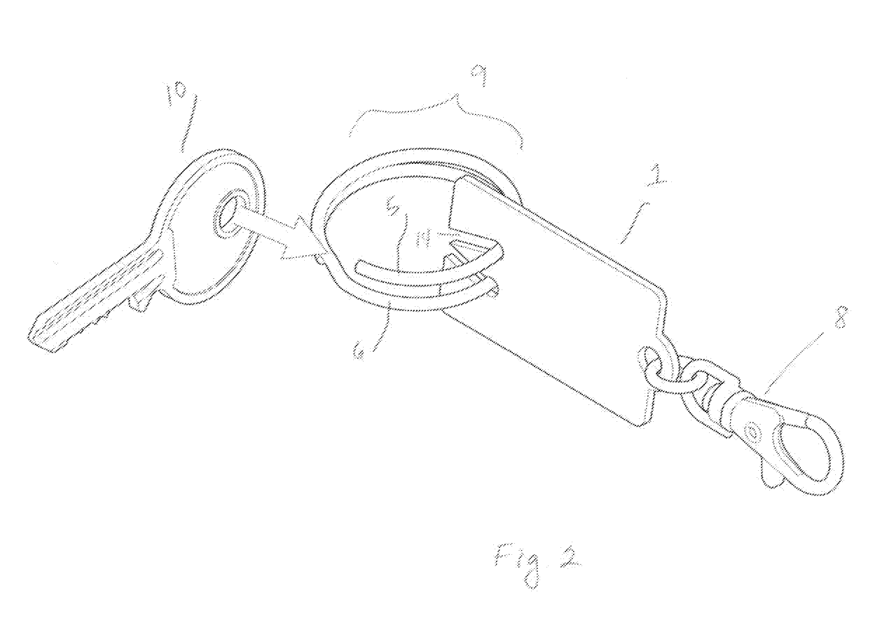

In certain embodiments, as seen, for example in FIG. 1, a tool 1 comprises a tapered prong 2 that has a broad portion 3 tapering to a pointed portion 4, the pointed portion configured to be inserted between the two contacting surfaces 5, 6 of a key ring 9. In certain embodiments, as seen, for example, in FIG. 2, the insertion of the tapered prong between the two contacting surfaces 5, 6 causes the two contacting surfaces to be separated them from each other by a distance that increases, incrementally or stepwise, as the tapered prong is advanced between the two contacting surfaces. For example, in various embodiments, any or all of the tapered prong comprises a substantially smooth line between the broad portion and the pointed portion; or a stepwise line between the broad portion and the pointed portion.

In certain embodiments, the tapered prong comprises one or more paths 14 terminating in one or more grooves 7 on or near the broad portion, configured to engage one or more of the contacting surfaces 5, 6 when the contacting surfaces have been separated to the point where the tapered prong can be advanced no further between them. As can be seen in FIGS. 1 and 2, when the one or more grooves 7 have fully engaged one or more of the contacting surfaces 5, 6, then serves as a full stop for the separation of the contacting surfaces. In certain embodiments, the one or more paths 14 leading to the one or more grooves 7 provide a substantially smooth and substantially uniformly dimensioned size, for example, a cylindrical path 14 having substantially the same diameter as that of the groove 7. In other embodiments, the dimensions of the one or more grooves are larger or offset from the one or more paths 14 (that is, the groove 7 has a larger diameter than the path 14, or is offset from the path at an angle), such that, once the respective contacting surface eases into the groove 7, it is not easily dislodged therefrom, and is seated snugly in a position that is fixed. In other embodiments, the base portion of the tapered prong has no such grooves to provide a fixed stopping point for the separation of the contacting surfaces, and a user can determine how far to advance the tapered prong between the contacting surfaces.

As used herein, “pointed portion” does not require an absolute point, but merely is used to convey that the tapered prong tapers from a generally broader base to a generally narrower portion that slips between the two contacting surfaces. For example, in certain embodiments, the tapered prong is essentially of triangular shape (with two or more of the three “sides” of the triangle being of either substantially equal or substantially unequal length). As used herein, “substantially equal” when referring to two or more values means that the values are within 10% of each other; “substantially unequal” means that the values are greater than 10% of each other. In various embodiments, the tapered prong tapers along a straight or curved line, and any portion of its shape can be symmetrical or asymmetrical. For example, one or more of the side prong surfaces 11, 12 of the tapered prong can be, in whole or in part, substantially smooth or substantially straight, to facilitate entry of the tapered prong into the space between the contacting surfaces. As used herein, “substantially smooth” means appearing smooth to the naked eye; “substantially straight” means appearing straight to the naked eye.

In still other embodiments, any part or whole of the tapered prong tapers along a line that is irregular or ridged, permitting the two contacting surfaces to be separated at fixed distances as the tapered prong advances in the space between the contacting surfaces.

In certain embodiments, the adjacent grooves are configured to engage the two separating surfaces as the tapered portion advances in the space formed between the two separating surfaces. Thus, this can permit a gradual increase, either smoothly or in a stepwise fashion, of the distance between the two separating surfaces, allowing for maximum flexibility in the size of the small personal item desired to be attached to the device that comprises the two separating surfaces (including but not limited to a keychain). Because the separation can be done gradually as the tapered portion advances, the risk of damage to the two separating surfaces is minimized. In the case of a keychain, in certain embodiments this is desirable as it minimizes the likelihood that the contacting surfaces of the keychain will be excessively stretched or deformed to the point where, once the apparatus is removed, the two contacting surfaces will not reform their previous tight connection. In certain embodiments, the tapered prong is shaped such that upon insertion between the contacting surfaces, the increase of the distance between the contacting surfaces occurs in a stepwise fashion. That is, any portion of the tapered prong can include angular portions, e.g., ridges, bumps or steps, such that the advancement of the tapered prong is done in discrete portions. This can provide additional stability for holding the contacting surfaces apart from each other, further avoiding slippage while the small personal item is being inserted between the contacting surfaces.

As can be seen in FIGS. 1 and 2, in certain embodiments the broad portion 3 is essentially the “base” of the triangle, and can be integrated into the larger apparatus, such that the tool is one continuous piece. In other embodiments, broad portion 3 can be more delineated from the remainder of the tool. Further, in certain embodiments, the tools herein can themselves be hooked onto a keychain or keychain hook 8. In certain embodiments, a tool herein can be just another one of multiple small personal items connected to a keychain, thereby providing a fast and easy way for a user to add small personal items to, and remove them from, the keychain.

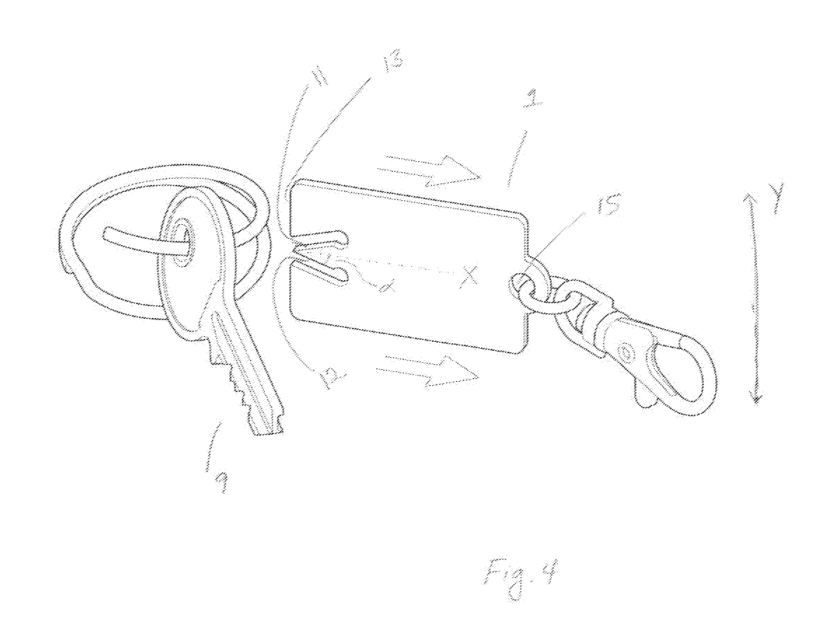

In certain embodiments, the tool can be of any shape including circular, oval, or a shape that has one or more curved or straight edges. In certain embodiments, as shown for example in FIG. 4, the tool 1 has a substantially quadrilateral shape having an external edge 13 from which the tapered prong is formed, such that the pointed portion 4 of the tapered prong extends along the plane of the external edge. As used herein, “substantially quadrilateral” means that the shape has between 4 and 6 sides. In certain embodiments, the tool is square, rectangular or rhomboid. For example, as shown in FIG. 1, the tool therein is rectangular even though one side has an outer edge space 16, and the opposite side has a curved portion to accommodate linkage to the keychain hook 8.

In certain embodiments, the tapered prong is formed only from the external edge of the tool (that is, a surface or opening facing outward), and not from an internal edge (that is, a surface or opening facing inward or on the inside of the tool). In certain embodiments, the tool 1 is solid throughout, other than the portion of the tool encompassing the tapered prong and the one or more grooves 7 and any holes configured to link the tool to a keychain hook 8 or some other item that is external to the tool (for example, the connecting hole 15 shown in FIG. 4). That is, there is no portion in the middle of the tool, or in any portion of the tool other than the external edge 13, that has a cut out portion or hole that includes any tapered prong or other portion configured to separate the contacting surfaces. In certain embodiments, there is an outer edge space 16 through which the pointed portion contacts the contacting surfaces. That is, the tool has at least one external side that is not uniformly solid in its entirety, and that side includes the outer edge space 16, such that the tapered prong extends externally from the tool (and the pointed portion faces toward the outer edge), rather than internally toward the interior of the tool (where the pointed portion faces away from the outer edge).

In certain embodiments, the pointed portion of the tapered prong extends no farther than the external edge 13 of the tool; in other embodiments, the pointed portion extends beyond the external edge 13 such that it protrudes out from the external edge 13.

In certain embodiments, a tool herein is configured such that, as shown for example in the Figures, the tool contacts the two contacting surfaces in a manner that the plane of the tool and the plane of the two contacting surfaces are substantially perpendicular to each other (that is, within 10 degrees of perpendicular). Put another way, in certain embodiments the tool is configured such that, held upright and advanced along its X axis, it engages the two contacting surfaces that are one on top of another in the Y direction, and the tapered prong is configured with its upper and lower plane surfaces 11, 12 contacting the contacting surfaces and advancing between them accordingly as shown in, e.g., FIG. 2.

The dimensions of the tool can be varied. In various embodiments, the length of the tool, that is, in the X direction from the outer edge 13 that engages the contacting surfaces, to the opposite edge that engages an external device such as a keychain hook, can be about 0.5 to about 3 inches, about 0.75 to about 2.5 inches, or about 1 to about 2 inches. In various embodiments, the width of the tool, that is, in the Y direction, can be about 0.25 to about 2 inches, about 0.5 to about 1.5 inches or about 0.75 to about 1.25 inches. In various embodiments, the thickness of the tool, that is, in the Z direction, can be about 0.05 to about 0.25 inches, or about 0.1 to about 0.2 inches.

In certain embodiments, as shown for example in FIG. 4, the pointed portion 4 comprises an upper or lower plane surface 11, 12, one or both of which are straight or curved, and can be configured to contact the upper contacting surface 5 or lower contacting surface 6 respectively, to provide a path 14 for the one or more contacting surfaces to glide and be guided toward the respective groove 7 for more secure holding as the tapered prong advances between the upper and lower contacting surfaces. In certain embodiments, such upper or lower plane surfaces 11, 12 can be of any width that will further ease the gliding toward the groove 7.

In certain embodiments, as shown for example in FIG. 4, the tapered prong is tapered at an angle a that is measured from the horizontal plane X; this angle α can be, in various embodiments, about 5 to about 30 degrees, about 8 to about 25 degrees, about 10 to about 20 degrees, or about 12 to about 15 degrees.

As seen in, e.g., FIG. 2, once the tool 1 is adequately inserted between the contacting surfaces 5, 6 and a space between them is formed, then a small personal item such as, but not limited to a key 10 can be inserted through the space in the direction of the arrow, and thereafter attached securely to the key ring 9.

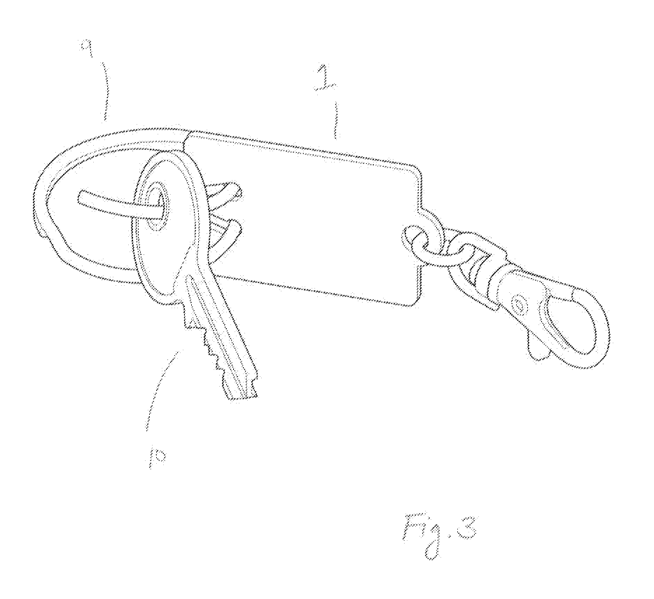

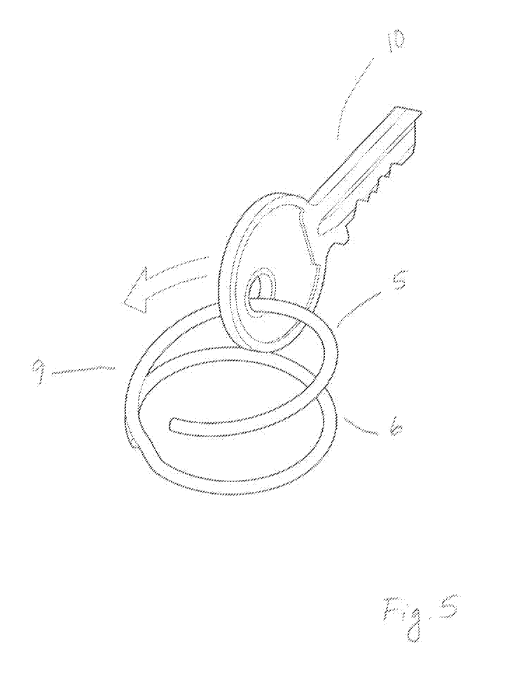

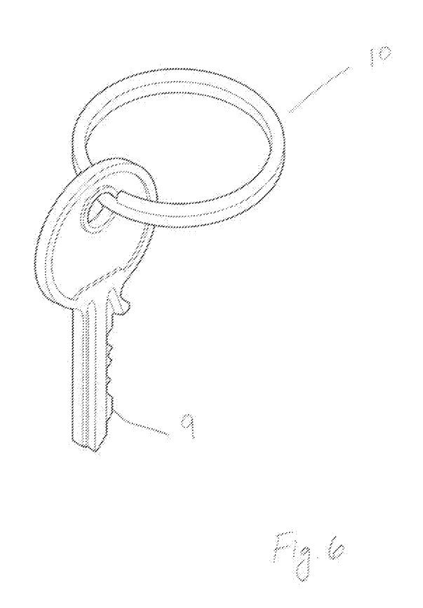

As shown in FIG. 3, the key 10 can then be advanced along the space between the contacting surfaces. In the embodiment pictured in FIG. 3, the key 10 touches the upper contacting surface 5 (but in other embodiments, can be advanced along any of the contacting surfaces, depending on the configuration of the surfaces with respect to each other). As shown in FIG. 4, the tool can then be disengaged from the contacting surfaces 5, 6 by moving it in the direction of the arrows. As shown in FIG. 5, the key 9 can then be continued in its advance along the upper contacting surface 5 in the direction of the arrow, until it “catches” and is fully engaged on the key ring, and the two contacting surfaces are back in contact with each other. As shown in FIG. 6, in this situation the key is thereby fully and securely inserted into the key ring 9, with minimal chance of being lost.

In various embodiments, the tool 1 can be any of a variety of shapes and sizes, including those not explicitly shown in the Figures, and in various embodiments can be of any shape or configuration that permits easy handling and transportation by a user. For example, in certain embodiments the tool is small enough to be easily carried in a user's hand, pocket, pocketbook or bag. In certain embodiments, the tool is a separate item from the key or other small personal items, and does not form any part thereof—this is advantageous as it permits the tool to be a separate item from any other small personal items that a user may want to add to, or remove from, the key ring or other carrying mechanism. In other embodiments, the tool can be integrated into any other small personal item mentioned herein, to provide a multi-function tool—for example, a tool herein combined with a flashlight, knife, multi-function tool or the like.

As discussed previously, in certain embodiments, the present technology is also directed to methods of inserting a small personal item onto a keychain comprising two surfaces in contact with each other, as well as methods of removing a small personal item from a keychain comprising two contacting surfaces in contact with each other. As discussed herein, inserting a small personal item and removing the small personal item can constitute the same steps but in reverse. Regardless of the purpose of separating the contacting surface, the tools herein can be used in the same way to separate them, whether for insertion or removal of the small personal item.

It is important to note that the present technology is not directed solely to methods of separating surfaces associated with keychains. Other embodiments are contemplated—for example, clasps and fastenings for jewelry or clothing, hardware, safety equipment, tools, toys and novelty items for recreation or sports, scientific and medical purposes or anything that will improve the ability to carry an item from one point to another without dropping or losing it.

The tools and apparatuses herein are useful in connection with any situation in which two contacting surfaces are desired to be separated by inserting a mechanism between them. An advantage of the apparatuses herein is that the tapered portion (optionally along with the one or more adjacent grooves) permits a user to separate the contacting surfaces in a more gentle and gradual manner, thus preserving the integrity of the tight hold between the contacting surfaces after the tool is withdrawn from them.

Although the present technology has been described in relation to particular embodiments thereof, these embodiments and examples are merely exemplary and not intended to be limiting. Many other variations and modifications and other uses will become apparent to those skilled in the art. The present technology should, therefore, not be limited by the specific disclosure herein, and may be embodied in other forms not explicitly described here, without departing from the spirit thereof.

What is claimed is:

1. A tool configured to separate two contacting surfaces from each other, the tool comprising a tapered prong having a broad portion tapering to a pointed portion, the pointed portion configured to be inserted between the two contacting surfaces, causing the two contacting surfaces to be separated them from each other by a distance that increases as the tapered prong is advanced between the two contacting surfaces.

2. The tool of claim 1, wherein the tapered prong is configured to separate two contacting rings of a keychain.

3. The tool of claim 1, further comprising a groove adjacent to the tapered prong, the groove configured to engage one of the two contacting surfaces and hold it apart from the other contacting surface as the tapered prong is advanced between the two contacting surfaces.

4. The tool of claim 3, comprising two grooves adjacent to the tapered prong, each groove configured to engage one of the two contacting surfaces and hold it apart from the other contacting surface as the tapered prong is advanced between the two contacting surfaces.

5. The tool of claim 1, wherein to tapered prong is formed from an external edge of the tool.

6. The tool of claim 1, wherein one or both of the two contacting surfaces comprises metal, plastic or wood.

7. The method of claim 1, wherein any or all of the tapered prong comprises a substantially smooth line between the broad portion and the pointed portion.

8. The tool of claim 1, wherein any or all of the tapered prong comprises a stepwise line between the broad portion and the pointed portion.

9. A method of separating two contacting surfaces from each other, the method comprising inserting the tool of claim 1 between the two contacting surfaces, separating them.

10. A method of inserting a small personal item onto a keychain comprising two surfaces in contact with each other, the method comprising the step of inserting the tool of claim 1 between the two surfaces to separate the surfaces and form a space between the two surfaces; and advancing the small personal item through the space.

11. A method of removing the a small personal item from a keychain comprising two surfaces in contact with each other, the method comprising the step of inserting the tool of claim 1 between the two surfaces to separate the surfaces and form a space between the two surfaces; and advancing the small personal item through the space.
